(19) United States
(12) Patent Application Publication
(10) Pub. No.: US 2018/0326978 A1
(43) Pub. Date: Nov. 15, 2018

(54) METHOD AND DEVICE FOR GENERATING AN ENVIRONMENT MODEL FOR A VEHICLE

(71) Applicant: GM GLOBAL TECHNOLOGY OPERATIONS LLC, Detroit, MI (US)

(72) Inventors: Viktor Wendel, Darmstadt (DE); Harald Berninger, Ruesselsheim (DE)

(73) Assignee: GM GLOBAL TECHNOLOGY OPERATIONS LLC, Detroit, MI (US)

(21) Appl. No.: 15/976,504

(22) Filed: May 10, 2018

(30) Foreign Application Priority Data
May 10, 2017 (DE) 102017004473.2

(51) Int. Cl. B60W 30/09; B60W 30/095; G01S 5/00; G08G 1/16; B60W 50/14

(52) U.S. Cl. CPC B60W 30/09; B60W 30/0953; B60W 30/0956; G01S 5/0072; H04W 4/46; G08G 1/166; B60W 50/14; B60W 2050/143; G08G 1/161

(57) ABSTRACT

A method for generating an environment model for a reference vehicle in a driving environment is disclosed. A data record is received from a third-party vehicle via a communication interface. The data record includes absolute position information of the third-party vehicle. The absolute position of the reference vehicle is determined. A relative position of the third-party vehicle is calculated based on absolute position information of the reference vehicle and the third-party vehicle. A relative position of an object in the driving environment is detected with a spatially resolving environment sensor on the reference vehicle. The detected object is correlated with the third-party vehicle when the calculated relative position of the third-party vehicle matches the detected relative position of the object.

### CROSS-REFERENCE TO RELATED APPLICATION

This application claims priority to German Patent Application No. 102017004473.2, filed May 10, 2017, which is incorporated herein by reference in its entirety.

### TECHNICAL FIELD

The present disclosure pertains to a method and device for modelling an environment surrounding a reference vehicle to output appropriate notification signals to a driver of the reference vehicle and/or intervene in the movement of an autonomous vehicle for minimizing the chance of an imminent collision between the reference vehicle and an object within the surrounding environment of the reference vehicle.

### BACKGROUND

From EP 1,865,479 A1, a method is known in which a reference vehicle receives information about its own position from a third-party vehicle and objects representing potential obstacles detected by the latter in order to supplement its own environment model by the objects when the third-party vehicle or an obstacle detected by the latter are at least partially located in a part of the environment which is not visible to an occupant of the reference vehicle. The accuracy of information about the location of an object that the third-party vehicle can provide is limited by the accuracy with which the third-party vehicle can determine its own position and the accuracy with which it can measure the position of the object relative to its own position. Measuring errors of the third-party vehicle can therefore lead to a misjudgment of the danger coming from the third-party vehicle or an obstacle it detects.

### SUMMARY

The present disclosure provides a method for creating an environment model in which the probability of such misjudgments is minimized. According to an embodiment of the present disclosure a data record including at least absolute position information of a third-party vehicle is received from the third-party vehicle via a communication interface. Based on absolute position information of the reference vehicle, a relative position of the third-party vehicle is calculated. Relative positions of objects in the environment to the reference vehicle are detected with the aid of a spatially resolving environment sensor. At least one of the objects with the third-party vehicle is equated with the position of the object detected by the environment sensor based on a match of the calculated relative position.

Equating object positions, once on the basis of the data record transmitted by itself and once based on the output of the environment sensor prevents a similar third-party vehicle from being represented multiple times in the environment model. Thus, the danger of the third-party vehicle itself being misjudged due to incorrect location information in the data record transmitted by it can first be prevented.

In order to facilitate the assessment of an imminent collision from the third-party vehicle, the data record received from there may also contain data on the velocity and/or course of the third-party vehicle. Such data can be used at times of the reference vehicle to calculate a current and/or a future relative position of the third-party vehicle. In determining the current position of the third-party vehicle, knowing the course and velocity of the third-party vehicle is particularly useful for compensating for a time difference between the time of calculation and the time at which the position data was acquired. On the basis of the same data on course and velocity but also a future location of the third-party vehicle, there can be an extrapolation of value for an assessment of the chance of an imminent collision between third-party and reference vehicle. In particular, there can be a decision to minimize the chance of collision based on the future relative position of the third-party vehicle via the output of a warning signal to the driver, which points to the chance of collision and/or via an autonomous intervention in the movement of the reference vehicle.

From the calculation of the relative position of the third-party vehicle, a trace can be estimated on the basis of which the presence of the third-party vehicle is evident in the signal of the environment sensor. By examining the signal of the environment sensor for the presence of the trace, the third-party vehicle may be detected at an early time. In particular, when it is certain, based on the received data record, that a third-party vehicle is present in the environment of the reference vehicle, the degree of similarity between the predicted and the found relative trace that must be reached can be set low in order to determine a location of the third-party vehicle based on the trace, so that the location of the third-party vehicle can be found earlier than in an “unbiased” evaluation of the environment sensor signal.

Detection of positions of objects can be disseminated by the reference vehicle to other vehicles via the communication interface in order to give the latter the option, where possible, of extending their environment model on the basis of these positions by the one or the other object which is not directly visible to the reference vehicle. Conversely, the data record received from the third-party vehicle may include positions of objects detected in the environment of the third-party vehicle. Then, the accuracy with which the positions of these objects relative to the reference vehicle is able to be calculated can be improved on the basis of the deviation between the position of the third-party vehicle detected by the environment sensor of the reference vehicle and the position determined by the third-party vehicle itself. Here, too, the information contained from the received data record that an object is located in the environment of the reference vehicle can be used to search specifically for the trace of such an object in the data supplied by the environment sensor and to identify the object earlier than in “unbiased” evaluation without prior information of the existence of the object.

In particular, the information about positions of objects supplied by the third-party vehicle can first be converted into relative second-hand positions with respect to the reference vehicle based on the known position of the reference vehicle, which information is not intrinsically trustworthy enough to output a warning signal to the driver or to make an intervention in the movement of the reference vehicle. This information can, however, be used to facilitate or accelerate the evaluation of environment sensor output signals and to determine first-hand relative positions based on these output signals that are trustworthy enough to justify a warning or an intervention in the movement of the reference vehicle.

The data record received from the third-party vehicle may further include classification information that associates each object detected in the environment of the third-party vehicle with a given object class. On the basis of membership in an object class, the trace of an object in the output signal of the environment sensor, such as an image section illustrating the object in an image supplied by a camera, can be accurately predicted and the image searched for the expected image section. The object class can also be used to estimate a future relative position of an object relative to the reference vehicle, and thus the possibility of endangering the object.

A processor of the reference vehicle itself may make an assignment of detected objects to object classes when evaluating the output signal of the environment sensor and classify objects not yet detected by the third-party vehicle or, if necessary, correct an assignment made by the third-party vehicle. In particular, the processor of the reference vehicle may differentiate between at least two groups of objects including objects capable of communication via the communication interface, object incapable of communication via the communication interface, motorized vehicles, non-motorized vehicles, pedestrians, animals or immobile objects. In the case of object capable of communication, a prediction of the future position is possible on the basis of data made available by the objects themselves. In the case of motorized vehicles, non-motorized vehicles, pedestrians, animals or immobile objects, objects of these classes differ in terms of achievable velocities, ability to make abrupt accelerations or course changes, which must be taken into account when estimating a future relative position.

The subject of the present disclosure is also directed to a device having a radio interface, an environment sensor and a processor, programmed with instruction sets to execute a method as follows. A data record which includes at least absolute position information of the third-party vehicle is received from a third-party vehicle via a communication interface. A relative position of the third-party vehicle is calculated based on absolute position information of the reference vehicle. Relative positions of objects in the environment of the vehicle detected with a spatially resolving environment sensor are received. One of the objects with the third-party vehicle is equated with the position of the object detected by the environment sensor based on a match of the calculated relative position.

Calculation of a relative position of the third-party vehicle may be set up to use data including the velocity and/or course of the third-party vehicle from the received data record for calculating a current and/or a future relative position. A warning signal and/or a control for performing an autonomous intervention in the movement of the reference vehicle may be output on the basis of the future relative position of the third-party vehicle.

Detection of relative positions of objects may be set up, based on the calculated relative position, to predict a trace of the third-party vehicle in the signal of the environment sensor and to examine the signal for the presence of the trace.

The communication interface may be set up to disseminate detected relative positions of objects to third-party vehicles. Conversely, positions received via the communication interface from objects detected in the environment of the third-party vehicle may be converted into relative second-hand positions with respect to the reference vehicle and to link with data from the environment sensor when detecting the relative positions. In particular, classification information from the received data record may be used to predict a trace of an object in the signal of the environment sensor and to examine the signal for the presence of the trace or to estimate a future relative position of an object.

Embodiments of the present disclosure include a computer program product with program code which enables a computer to execute the method described above or to operate as a processor in the above-mentioned device, and by a computer-readable data carrier, on which are recorded program instructions that enable a computer to operate as stated above.

### BRIEF DESCRIPTION OF THE DRAWINGS

The present disclosure will hereinafter be described in conjunction with the following drawing figures, wherein like numerals denote like elements.

FIG. 1 shows a traffic situation in which the present disclosure is applicable; and

FIG. 2 shows a flowchart of a method according to the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

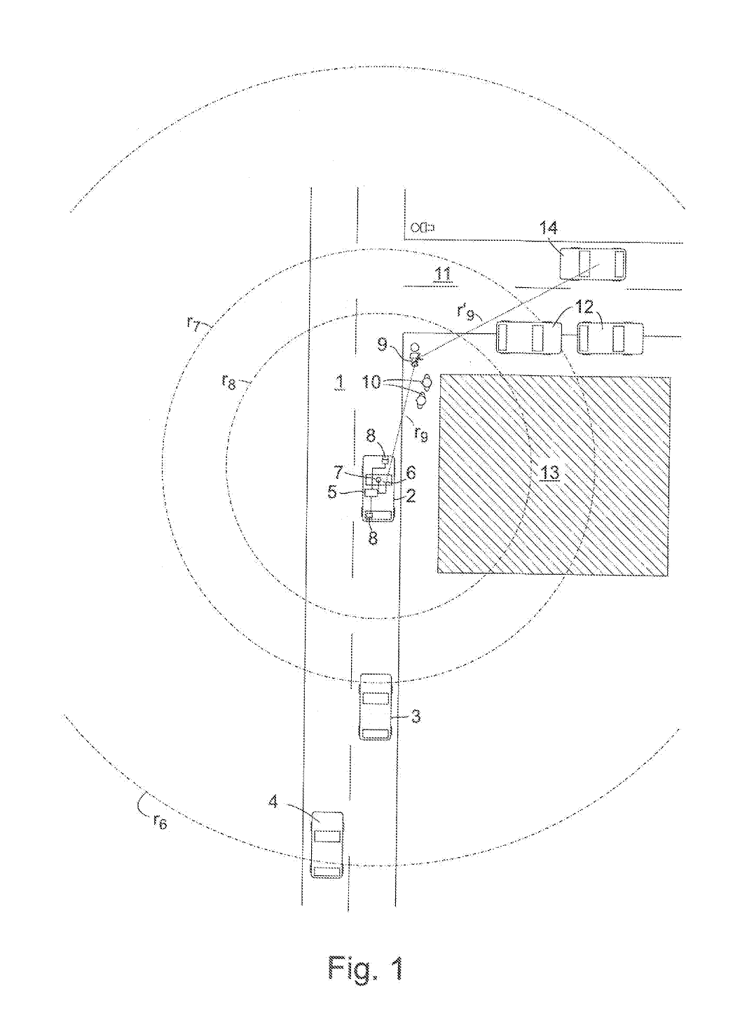

FIG. 1 shows a schematic top view of a road 1 and three vehicles 2, 3, 4, which move on the road 1 in generally the same direction. The foremost of the three vehicles, hereinafter referred to as reference vehicle 2, has an on-board computer 5 and a radio interface 6, which allows the on-board computer 5 to communicate with on-board computers of third-party vehicles, for example to the rear third-party vehicle 4 and the calculation of the position of the reference vehicle 2 based on navigation satellite signals, such as GPS signals. The third-party vehicle(s) may likewise include an on-board computer and a radio interface and a GPS or similar system to determine the position of the third-party vehicle(s) based on navigation satellite signals. The reference vehicle 2 also has various environment sensors, such as a radar sensor 7 and a camera 8. The range of the radio interface 6 is greater than the range of the radar sensor 7 and the camera 8, so that when the third-party vehicle 4 approaches the reference vehicle 2, the on-board computers are able to communicate with each other via the radio interface 6, even before the third-party vehicle 4 has come close enough to be detected by the radar sensor 7 or the camera 8. The range r6 of the radio interface 6 is typically about 1000 ft. (300 m), while the range r7 of the radar sensor 7 at about 500 ft. (150 m) and the range r8 of the camera 8 may be about 330 ft. (100 m).

The third-party vehicles 3,4 periodically emits data packets that contain a third-party vehicle-specific identification, a time stamp, and information on the position of the third-party vehicles 3, 4 at the time specified by the time stamp, expressed as the geographical longitude and latitude, as well as information about the velocity and the course of the third-party vehicle 4. The accuracy with which currently used civil GPS systems can determine a position is 5 ft. (1.5 m) under favorable conditions. Based on the received data packets and the reference vehicle position data determined by on-board computer 5, the reference vehicle 2 is therefore not able to distinguish whether the third-party vehicle 4 is traveling on the same lane as the reference vehicle 2. In order to warn the driver of the reference vehicle 2 of the third-party vehicle 4 and to prevent a change of the reference vehicle 2 into the fast lane in the event that the third-party vehicle 4 approaches on another lane and is expected to overtake, there must be recourse to the environmental sensors 7, 8.

Data from the environment sensors 7, 8 provide different information about objects in the environment of the reference vehicle 2. In the situation shown in FIG. 1, a traffic light 9 and waiting pedestrians 10 are located within the range r8. The traffic light 9 and the pedestrians 10 are identified by the on-board computer 5 in a manner known, e.g. image processing, and inserted in the form of a data record, which respectively contains the coordinates and group membership of an identified object, in an environment model of the area surrounding the reference vehicle 2 maintained by the on-board computer 5.

In the circumstance depicted in FIG. 1, the third-party vehicle 3 is too far away to be detected by the camera 8, but is within range r7 of the radar sensor 7. The radar sensor 7 provides information about the distance of the third-party vehicle 3 and the direction in which it can be found from the reference vehicle 2, that is, the coordinates of the vehicle 3, and its velocity. By matching with the coordinates of objects detected via the camera, it can be determined whether an object detected by the radar sensor 7 and an object detected by the camera 8 are identical such that their data may be combined into one data record in the environment model, or whether they are different objects, each of which has its own data record. In the case considered here, the third-party vehicle 3 gets its own data record. The detected velocity of the third-party vehicle 3 may also be noted in this data record. Based on the velocity, the third-party vehicle 3 is recognizable as a motor vehicle for the on-board computer 5 and this group membership may also be noted in the data record. The third-party vehicle 4 is not recognizable either for the camera 8 or for the radar sensor 7. A data record of the third-party vehicle 4 in the environment model is therefore based on the data transmitted by the third-party vehicle 4 itself, which gives information about the identification, group membership, coordinates and velocity.

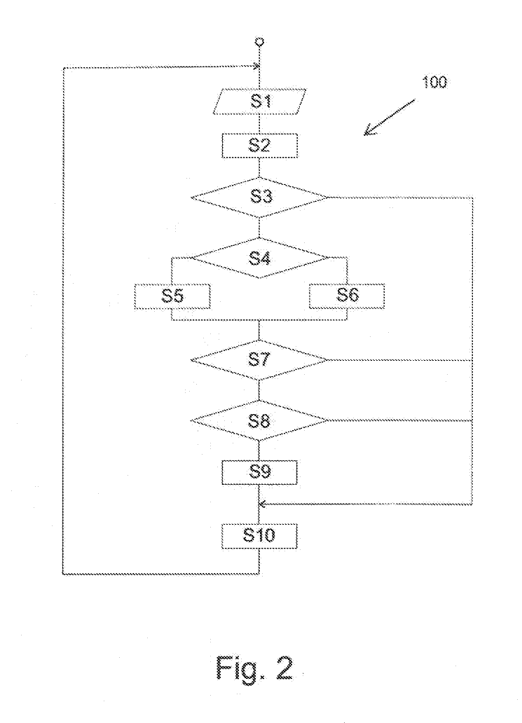

FIG. 2 illustrates the processing of data concerning the third-party vehicle 4 by the on-board computer 5 with reference to a flowchart 100. At regularly recurring times, the on-board computer 5 receives data of the environment sensors 7, 8 at S1 and processes them at S2.to determine if it is necessary to warn the driver of a chance or to prevent a dangerous maneuver, as well as to update the environment model in the on-board computer 5 and disseminate the data associated with environment model via the radio interface 6 to third-party vehicles. The processing at S2 includes, among other things, searching the data provided by the environment sensors 7, 8 for patterns that are characteristic of particular groups of objects that may be located in the environment of the reference vehicle. The on-board computer 5 may identify an approaching third-party vehicle on the basis of the data from the radar sensor 7. There must be a solid angle of predefined minimum size in these data, for which the radar measurement indicates a negative velocity. In the data of the camera 8, a vehicle outline having a predefined minimum size must be made out. During processing or during the waiting time between the processing and the next data acquisition, a data packet can arrive via the radio interface 6 at any given time.

If it is determined at S3 that a data packet has arrived, the on-board computer 5 first examines at S4 whether the identifier of the received packet matches that of a data record in the environment model. If not, a new data record is created at S5 to store the received data therein. Otherwise an existing data record is updated with the received data at S6.

The position of the third-party vehicle 4, which is entered into the data record at S5 or S6, is generally not exactly the position X_{GPS} transmitted by the third-party vehicle itself, but rather a corrected position:

Xₜ_{₀}=X_{GPS}v̅*Δt

wherein v̅ is the velocity vector specified in the data packet by velocity amount and course and Δt is the difference between the time specified in the time stamp of the data packet (ttimestamp) and the time of the most recent data acquisition by the environment sensor 7, 8 (t₀):

Δt=t₀−tₜᵢₘₑₛₜₐₘₚ

Thus, the position Xₜ_{₀} recorded in the data record corresponds to the location at which the third-party vehicle 4 was presumably located at the time to of the most recent data acquisition. If the distance r of the third-party vehicle 4 from the reference vehicle 2 is far beyond the ranges r7, r8 of the environment sensors 7, 8, the processing of the data packet may end at this point and the process returns to the starting point at S7.

Otherwise, the on-board computer 5 examines the data of the environment sensors 7, 8 of the environment sensors for traces of the third-party vehicle 4 at S8. Since the third-party vehicle 4 has not yet been recognized in the evaluation at S2, this trace is not clear enough to exceed the detection threshold in the processing based only on the data of the environment sensors 7, 8. Therefore, the search for these traces at S8 is restricted to a section of the solid angle monitored by the environment sensors 7, 8, which angle lays in the direction of the presumed location Xₜ_{₀} of the third-party vehicle 4 from the reference vehicle 2. Within this limited section, the detection threshold is lowered in comparison with the processing at S2. In other words, a smaller solid angle suffices with the relative velocity in the data of the radar sensor 7 matching the velocity v of the third-party vehicle 4, or a smaller or more incomplete outline in the image data of the camera 8, in order to identify the third-party vehicle 4. Effectively this corresponds to a selective extension of the ranges of the environment sensors 7, 8 beyond r7 or r8 for third-party vehicles announcing their approach by sending out data packets.

The size of the section examined at S8 is set such that the trace of the third-party vehicle 4 must be securely located in the section taking into account the inaccuracy of the position data. This inaccuracy varies according to reception conditions. Methods for estimating them on the basis of the received satellite signals are known and can be used within the scope of the present disclosure in order to select a larger size of the examined section under poor reception conditions than under good conditions. In order to minimize the likelihood that noise of the sensor data is erroneously identified as an object, the detection threshold in a large examined section can be set higher than in a small section.

When, in the search at S8, the trace of the third-party vehicle 4 is found, the data record is supplemented at S9 by the direction in which the third party vehicle 4 is visible from the reference vehicle 2. This direction may be specified by a vectorial difference between the positions of the vehicles 2, 4 or by a course angle. Thus, data that are obtained in the next iteration at S1, S2 related to this direction can be immediately assigned to the data record of the reference vehicle 2, and the application of two data records related to the same third-party vehicle 4 is avoided.

To prepare for iterations at S1, S2 at time t₁, the data records for each object of the environment model are updated in at S10 by estimating the expected position of the relevant object at time t₁:

Xₜ_{₁}=Xₜ_{₀}+v̅*(t₁−t₀)

In the case of an object sending data packets, such as the third-party vehicle 4, the velocity vector v̅ is derived from the information contained in the data packet, in the case of other road users such as the third-party vehicle 3, bicycles, pedestrians 10, etc. of successive measurements of their position with the aid of the environment sensors 7, 8.

Further, depending on the group membership of each object, a fuzziness of the estimated position Xₜ_{₁} is set. This fuzziness depends on the ability of the object to accelerate or decelerate and is higher for a motorized object such as the third-party vehicles 3, 4 than for non-motorized vehicles such as pedestrians 10. For a non-moving object like the traffic light 9, the fuzziness is 0. Based on this fuzziness, an angle section from the data of the environment sensors is determined in each case, by then searching for the pattern characteristic for the object in question at S2. Thus, the computational effort for the detection of individual objects and the probability of recognition errors can be minimized. The interaction of the environment sensors 7, 8 with the radio interface 6 thus allows a sustained monitoring and reliable detection of an approaching vehicle and a reliable prognosis of its further movement. If the third-party vehicle 4 actually starts to overtake the reference vehicle 2, this event is recognized with a high degree of certainty and the driver of the reference vehicle 2 is warned or an attempt by the driver to change the lane, if necessary, can be stopped autonomously by the on-board computer 5.

The radio transmission between different vehicles also makes it possible to supplement the environment model maintained by the reference vehicle 2 with objects which neither participate in the radio communication themselves nor lie within the detection range of the environment sensors 7, 8. Thus, FIG. 1 shows an intersecting cross street 11 opening at the traffic light 9, at the edge of which cross street vehicles 12 are parked and thereby block a part of the road. Direct detection of these vehicles 12 by the environment sensors 7, 8 of the reference vehicle 2 is prevented by a building 13 blocking the line of sight. On the cross street 11 is another third-party vehicle 14 on the road, which in turn maintains an environment model as described above and disseminates via radio. The environment of this vehicle 14 includes both the parked vehicles 12 and the traffic light 9. Consequently, the data packets disseminated by the vehicle 14, in addition to the already mentioned information on identity, position and velocity of the vehicle 14, also contain such for the position of the vehicles 12 and the traffic light 9.

When the reference vehicle 2 receives a data packet of the vehicle 14, according to the method described above, this first leads to a supplement of the environment model of the reference vehicle 2 by a data record which describes the vehicle 14 and its movement. The position of the vehicle 12 relative to the reference vehicle 2, which the on-board computer 5 calculates in this case, is based on GPS position determinations of both vehicles 2, 14 and therefore cumulates their errors. According to a further development of the method, however, this error is reduced by the on-board computer5 checking each data record obtained from the data packet of the vehicle 14 on whether it concerns an object already registered in the environment model of the reference vehicle 2. Such a check may be based on position and group membership of an object. In the case considered here, the environment model of the reference vehicle 2 does not yet contain the vehicle 14 or the parked vehicles 12, but both environment models contain an unmoving object, namely the traffic light 9, at matching absolute positions within the accuracy of the GPS measurements. The relative position of the traffic light 9 with respect to the reference vehicle 2, shown in the FIG. 1 as a vector r₉, is registered in the environment model of the reference vehicle 2; its relative position r′₉ in relation to the vehicle 14 is included in the received data packet. The difference of both vectors indicates the position of the vehicle 14 relative to the reference vehicle 2 uninfluenced by errors of the GPS position determination and enables an exact conversion of the positions of the vehicles 12 in positions relative to the reference vehicle 2 determined by the vehicle 14 relative to its own position. Thus, the on-board computer 5, by comparing related data obtained from a vehicle navigation system with the position of the cross road 11, is able to recognize that the vehicles 12 are narrowing the road and to point out the road constriction to the driver of the reference vehicle 2—in particular if he announces his intention to turn into the cross street 11 by setting the turn signal.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-14 (canceled)

15. A method for generating an environment model for a reference vehicle in a driving environment comprising:
receiving a data record including absolute position data of a third-party vehicle via a communication interface of the reference vehicle;
determining absolute position data of the reference vehicle;
calculating a relative position of the third-party vehicle with respect to the reference vehicle based on the absolute position data of the reference vehicle and the third-party vehicle;
detecting a relative position of an object in the driving environment with respect to the reference vehicle in an environment sensor signal; and
correlating the object with the third-party vehicle in the environment model when the calculated relative position of the third-party vehicle matches the detected relative position of the object.

16. The method according to claim 15, further comprising:
receiving data including a velocity of the third-party vehicle in the data record from the third-party vehicle; and
calculating a future relative position of the third-party vehicle with respect to the reference vehicle based on the calculated relative position and the velocity of the third-party vehicle.

17. The method according to claim 16, further comprising generating a control signal when the future relative position of the third-party vehicle conflicts with an anticipated position of the reference vehicle.

18. The method according to claim 17, wherein the control signal comprises a warning signal.

19. The method according to claim 17, wherein the control signal comprises an autonomous intervention in the movement of the reference vehicle.

20. The method according to claim 15, further comprising predicting a trace of the third-party vehicle in the environment sensor signal based on the detected relative position and querying the environment sensor signal for the presence of the trace.

21. The method according to claim 15, further comprising disseminating the detected position of the object via the communication interface.

22. The method according to claim 15, further comprising receiving data including a relative position of an object with respect to the third-party vehicle detected by the third-party vehicle in the data record from the third-party vehicle.

23. The method according to claim 22, converting the relative position of the object detected in the driving environment of the third-party vehicle into a relative second-hand position with respect to the reference vehicle, and using the relative second-hand position when detecting the relative position of the object with respect to the reference vehicle in the environment sensor signal.

24. The method according to claim 22, further comprising receiving data including classification information associated with the object detected in the driving environment by the third-party vehicle in the data record from the third-party vehicle.

25. The method according to claim 24, further comprising predicting a trace of the third-party vehicle in the environment sensor signal based on the classification information and querying the environment sensor signal for the presence of the trace.

26. The method according to claim 24, further comprising calculating a future relative position of the object based on the classification information.

27. The method according to claim 24, further comprising differentiating an object class based on the classification information, wherein the object class is selected from the group consisting of an object capable of communication via the communication interface or an object incapable of communication via the communication interface, motorized or non-motorized vehicles, pedestrians, animals or immobile objects.

28. The method according to claim 24, further comprising differentiating an object class based on the classification information, wherein the object class is selected from the group consisting of a motorized vehicle, a non-motorized vehicles, a pedestrian, an animal or an immobile object.

29. A computer program product comprising a processor and memory associated with the processor having program instructions which enables the processor to execute the method of claim 15.

30. A non-transitory computer-readable medium comprising program instructions recorded thereon which enable a computer to execute the method according to claim 15.

31. A device for generating an environment model on board a reference vehicle in a driving environment comprising:
a communication interface;
a spatially resolving environment sensor; and
a processor configured to:
receive a data record including absolute position data of a third-party vehicle via the communication interface;
determine absolute position data of the reference vehicle;
calculate a relative position of the third-party vehicle with respect to the reference vehicle based on the absolute position data of the reference vehicle and the third-party vehicle;
detect a relative position of an object in the driving environment with respect to the reference vehicle with the spatially resolving environment sensor; and
correlate the object with the third-party vehicle in the environment model when the calculated relative position of the third-party vehicle matches the detected relative position of the object.
